(19) United States
(12) Patent Application Publication
(10) Pub. No.: US 2006/0145661 A1
(43) Pub. Date: Jul. 6, 2006

(54) System and method for operating a multiple charger

(76) Inventors: Joseph Patino, Pembroke Pines, FL (US); Russell L. Simpson, Miami, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/026,886

(22) Filed: Dec. 30, 2004

(51) Int. Cl. H02J 7/00

(52) U.S. Cl. 320/116

(57) ABSTRACT

The invention concerns a method (300) and system (100) for operating a multiple charger. The method can include—in a multiple charger (110) having at least a first switch (134) and a second switch (122) for respectively controlling the flow of current to a first battery (116) and a second battery (118)—charging (312) the first battery by maintaining the first switch in a saturated state and charging (314) the second battery by maintaining the second switch in a saturated state. The first switch and the second switch can be simultaneously maintained (314) in the saturated state at least until the first battery reaches a predetermined charging threshold (412, 414).

### BACKGROUND OF THE INVENTION

1. Field of the Invention

This invention relates in general to rechargeable batteries and more particularly to methods used to recharge such batteries.

2. Description of the Related Art

Portable electronic devices have become ubiquitous in today's society. These devices are generally powered by one or more rechargeable batteries. For example, most cellular telephones can be coupled to a charger that can charge the telephone's battery after several hours, depending on how badly the battery is depleted. To increase the availability of such portable devices, many consumers have purchased dual or multiple chargers, units that are capable of receiving and charging at least two batteries. Unfortunately, the charging sequences employed by many of these charging units cause the charging units to give off excessive heat, i.e., waste power, and to take too much time to charge the batteries.

### SUMMARY OF THE INVENTION

The present invention concerns a method for operating a multiple charger system. The method can include the steps of—in a multiple charger system having at least a first switch and a second switch for respectively controlling the flow of current to a first battery and a second battery—charging the first battery by maintaining the first switch in a saturated state and charging the second battery by maintaining the second switch in a saturated state. In one arrangement, the first switch and the second switch can be simultaneously maintained in the saturated state at least until the first battery reaches a predetermined charging threshold.

The method can also include the step of—while at least one of the first and second switches is in the saturated state—maintaining in a current limited state a power supply that can provide the current to the first and second batteries. Maintaining the power supply in the current limited state can reduce a voltage of the power supply in comparison to maintaining the power supply in a non-current limited state. This step can reduce a power dissipation in the multiple charger.

In another arrangement, the method can include the steps of maintaining the first switch in a saturated state and deactivating the second switch until the first battery reaches the predetermined charging threshold a first time. The method can also include the step of maintaining the first and second switches in the saturated state at least until the first battery reaches the predetermined charging threshold a second time. The method can further include the step of maintaining the second switch in the saturated state until the second battery reaches a second predetermined charging threshold.

In yet another arrangement, once the first battery reaches the predetermined threshold a first time, the method can further include the steps of maintaining the first switch in a non-saturated state and maintaining the second switch in the saturated state at least until the second battery reaches a second predetermined threshold. As an example, at least one of the first battery and the second battery can be used to power a mobile communications device.

The present invention also concerns a system for operating a multiple charger. In one arrangement, the system can include a first switch that controls the flow of current to a first battery, a second switch that controls the flow of current to a second battery and a processing unit coupled to the first switch and the second switch. The processing unit can be programmed to charge the first battery by maintaining the first switch in a saturated state and to charge the second battery by maintaining the second switch in a saturated state. The processing unit can also be programmed to maintain the first switch and the second switch in the saturated state simultaneously at least until the processing unit detects that at least one of the first battery and the second battery has reached a predetermined charging threshold. The system can include suitable software and circuitry for performing the processes described above.

The present invention also concerns a charger for charging multiple batteries. The charger can include a first switch that controls the flow of current from a power supply to a first battery and a processor coupled to the first switch. The processor can be programmed to charge the first battery by maintaining the first switch in a saturated state at the same time that a second switch is maintained in a saturated state to permit current to flow to a second battery. The processor can be further programmed to maintain the first switch in the saturated state while the second switch is in the saturated state at least until the processor detects that at least one of the first battery and the second battery has reached a predetermined charging threshold. The charger can also include suitable software and circuitry for performing the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for charging one or more batteries in accordance with an embodiment of the inventive arrangements;

FIG. 2 illustrates an exemplary schematic diagram of the system of FIG. 1 in accordance with an embodiment of the inventive arrangements;

FIG. 3 illustrates a method for operating a multiple charger in accordance with an embodiment of the inventive arrangements;

FIG. 4 illustrates examples of charging graphs in accordance with an embodiment of the inventive arrangements; and

FIG. 5 illustrates more examples of charging graphs in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and system for operating a multiple charger. In one arrangement, the method can include the steps of—in a multiple charger having at least a first switch and a second switch for respectively controlling the flow of current to a first battery and a second battery—charging the first battery by maintaining the first switch in a saturated state and charging the second battery by maintaining the second switch in a saturated state. The first switch and the second switch can be simultaneously maintained in the saturated state at least until the first battery reaches a predetermined charging threshold.

The method can also include the step of—while at least one of the first and second switches are in the saturated state—maintaining in a current limited state a power supply that provides the current to the first and second batteries. The step of maintaining the power supply in the current limited state can reduce a voltage of the power supply in comparison to maintaining the power supply in a non-current limited state, which can reduce a power dissipation in the multiple charger.

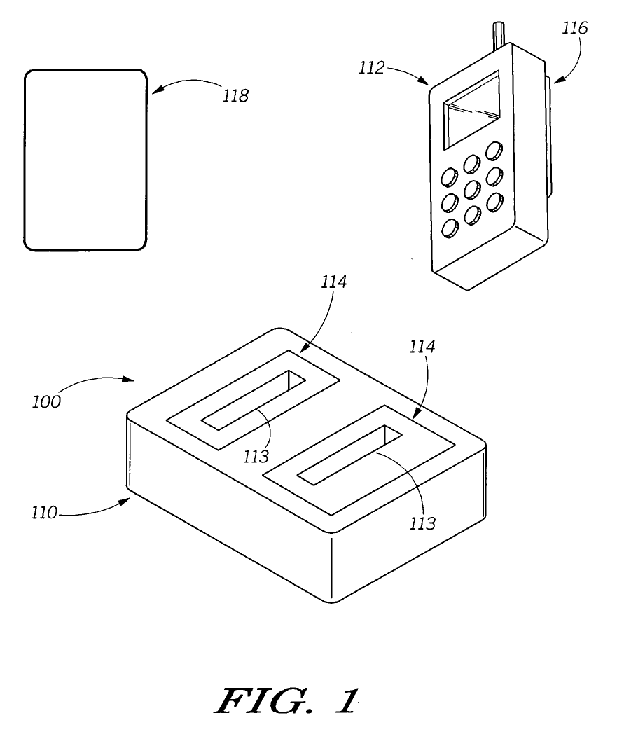

Referring to FIG. 1, a system 100 that can be used to charge one or more batteries is shown. The system 100 can include a charger 110 for charging a portable electronic device 112 or a portable power source, such as a battery. The charger 110 can be a multiple charger, which means that the charger is capable of charging one or more batteries at any given time. As another example, the portable electronic device 112 can be a cellular telephone, a two-way radio, a personal digital assistant or a messaging device. It is understood, however, that the invention is not limited in this regard, as the portable electronic device 112 can be any portable unit that relies at least in part on batteries for its power supply.

The charger 110 can include one or more pockets 114 for receiving the portable electronic device 112, and the pockets 114 can include one or more receptacles 113 for transferring power from a power supply to the portable electronic device 112. For example, the portable electronic device 112 can include a first battery 116, and when the portable electronic device 112 is coupled to the receptacle 113, the first battery 116 can be charged.

In one particular arrangement, the charger 110 can be a dual pocket charger, which can include two pockets 114. One of the pockets 114 can be designed to receive the portable electronic device 112, and the other pocket 114 (and its receptacle 113), as alluded to earlier, can be designed to receive a second battery 118. In accordance with this example, the charger 110 can charge both the first battery 116 of the portable electronic device 112 and the second battery 118. The second battery 118 can be attachable to the portable electronic device 112 and can provide power to the portable electronic device 112. As a result, a user of the portable electronic device 112 can enjoy the benefits of a fully charged first battery 116 and can have a backup battery, i.e., the second battery 118, readily available when the charge on the first battery 116 is depleted.

It must be noted that the charger 110 is in no way limited to this particular configuration, as it can include any suitable number of pockets 114 for receiving any suitable type of chargeable item. Moreover, the second battery 118 may be considered to be the battery to power the portable electronic device 112, while the first battery 116 can be a backup battery. Those of ordinary skill in the art will appreciate that any suitable type of battery can be used with the system 100. In fact, the first battery 116 and the second battery 118 can be any suitable portable power source.

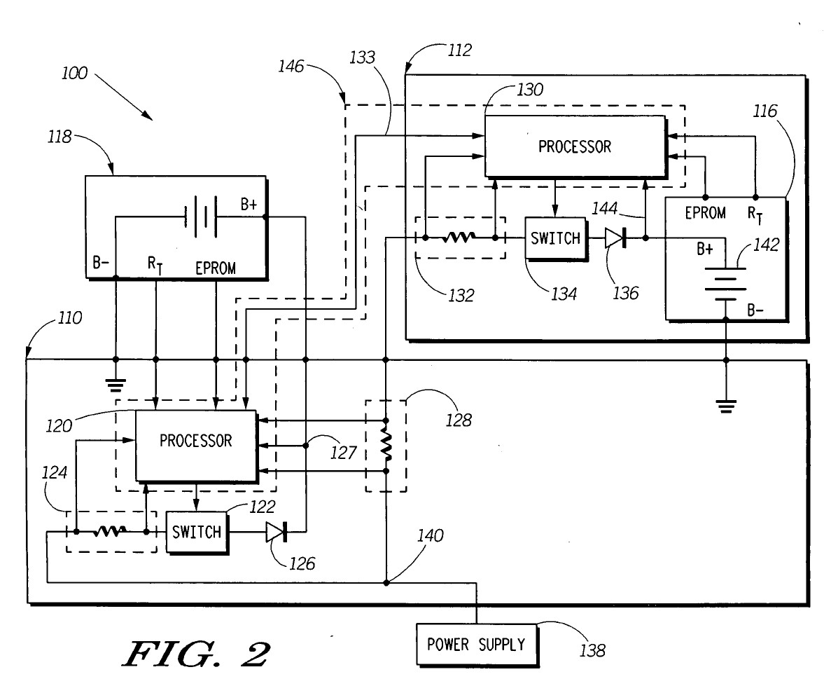

Referring to FIG. 2, an example of a schematic of the system 100 of FIG. 1 is shown. Here, the charger 110 can include a processor 120, a switch 122, a current sensor 124, a diode 126 and another current sensor 128. The output of the diode 126 can lead to a voltage input B+ for, as an example, the second battery 118. In one arrangement, the input to the current sensor 124 can be coupled to a power supply 138 through a node 140. Through the current sensor 124, the processor 120 can monitor the amount of current that is being transferred to a set of cells 119 of the second battery 118. The processor 120 may also monitor the voltage output of the power supply 138 through the current sensor 124. Further, through the current sensor 128, the processor 120 can monitor the voltage of the power supply 138 and the amount of current flowing to the switch 134.

The processor 120 can also regulate the amount of current flowing to the second battery 118 by controlling the operation of the switch 122. As an example, the switch 122 can be a field effect transistor (FET), although other suitable devices can serve as the switch 122.

The processor 120 can monitor the voltage of the second battery 118 through an input 127. The processor 120 can also access information concerning the operating parameters of the second battery 118 through an erasable programmable read-only memory (EPROM) input and can monitor the temperature of the second battery 118 through a thermistor (R_{T}) input. The information about the second battery 118 that can be accessed through the EPROM input can include a maximum charging voltage, a maximum charging current, a minimum charging current and, in certain cases, a maximum temperature rate. This information can be helpful during the charging process.

The portable electronic device 112 can include a processor 130, a current sensor 132, a switch 134 and a diode 136. Similar to the second battery 118, the output of the diode 136 can lead to a voltage input B+ for, as an example, the first battery 116 of the portable electronic device 112. The input to the current sensor 132 can also be coupled to the power supply 138 through the node 140. Further, the processor 130, via the current sensor 132, can monitor the flow of current to a set of cells 142 of the first battery 116 and the voltage output of the power supply 138. In another arrangement, a data or input/output (I/O) line 133 can couple the processor 120 to the processor 130 to permit them to exchange information.

The processor 130 can also regulate current flow to the first battery 116 by regulating the operation of the switch 134, which, as an example, can be an FET. Those of ordinary skill in the art, however, will appreciate that the switch 134 can be any other suitable device for regulating current flow. For convenience, the switch 134 can be referred to as the first switch 134, and the switch 122 can be referred to as the second switch 122.

Like the processor 120, the processor 130 can monitor the voltage of the first battery 116 through an input 144, can retrieve information about the first battery 116 via an EPROM input and can check the temperature of the first battery 116 through an R_{T} input. The retrieved information can concern a maximum charging voltage, a maximum charging current, a minimum charging current and possibly a maximum temperature rate, which the processor 130 can use to facilitate the charging of the first battery 116.

In one arrangement, the processor 120 and the processor 130 can be part of a processing unit 146, which is represented by the dashed outline in FIG. 2. In this example, the processing unit 146 can include two discrete processors, namely the processor 120 and the processor 130. Nevertheless, it is understood that the processing unit 146 can include merely one processor or more than two processors for controlling the charging of any batteries.

For example, those of ordinary skill in the art will appreciate that a single processor can be implemented in the portable electronic device 112, which can be used to carry out the charging process. As a more specific example, the portable electronic device 112 can be designed to carry both the first battery 116 and the second battery 118 simultaneously. A single processor, or processing unit, in the portable electronic device 112 can monitor the current flowing to the first and second batteries 116, 118 and their voltages.

Likewise, those of ordinary skill in the art will appreciate that a single processor, or processing unit, can be incorporated in the charger 110 for executing the charging sequence. This processor can also monitor current flowing to the first and second batteries 116, 118 and their voltages. A charger with a single processor may be useful in charging two batteries in which neither battery is coupled to an electronic device. It is important to stress that the invention is not limited to any of these particular examples, as other suitable configurations are within the scope of the inventive arrangements.

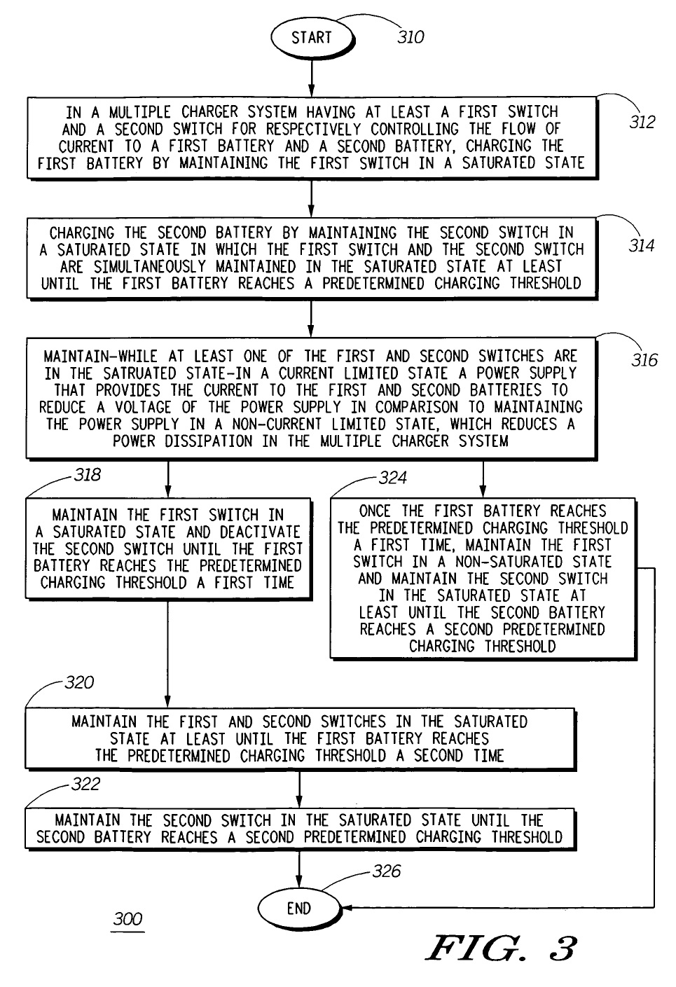

Referring to FIG. 3, a method 300 for operating a multiple charger is shown. To describe the method 300, reference will be made to FIGS. 1 and 2, although it is understood that the method 300 can be implemented in any other suitable device or system using other suitable components. Moreover, the invention is not limited to the order in which the steps are listed in the method 300. In addition, the method 300 can contain a greater or a fewer number of steps than those shown in FIG. 3.

At step 310, the method 300 can begin. At step 312, in a multiple charger system having at least a first switch and a second switch for respectively controlling the flow of current to a first battery and a second battery, the first battery can be charged by maintaining the first switch in a saturated state. At step 314, the second battery can be charged by maintaining the second switch in a saturated state. In one arrangement, the first switch and the second switch can be simultaneously maintained in the saturated state, at least until the first battery reaches a predetermined charging threshold.

At step 316, a power supply can be maintained in a current limited state while at least one of the first and second switches are in the saturated state. The power supply can provide current to the first and second batteries. This step can reduce a voltage of the power supply in comparison to maintaining the power supply in a non-current limited state, which reduces a power dissipation in the multiple charger system. There are several ways to carry out the steps recited above, and at least two alternatives will be described here.

For example, at step 318, the first switch can be maintained in a saturated state, and the second switch can be deactivated, at least until the first battery reaches the predetermined charging threshold a first time. Also, the first and second switches can be maintained in the saturated state at least until the first battery reaches the predetermined charging threshold a second time, as shown at step 320. The second switch can be maintained in the saturated state until the second battery reaches a second predetermined charging threshold, as shown at step 322. The method 300 can then end at step 326.

For example, referring to FIGS. 1 and 2, the portable electronic device 112 may contain the first battery 116, which can be coupled to a receptacle 113 of a pocket 114 of the charger 110. In addition, the second battery 118 can be coupled to the receptacle 113 in the remaining pocket 114. Of course, the invention is not limited to this particular arrangement, as any other number of batteries can be coupled to any other suitable charger capable of receiving any number of elements that can be charged.

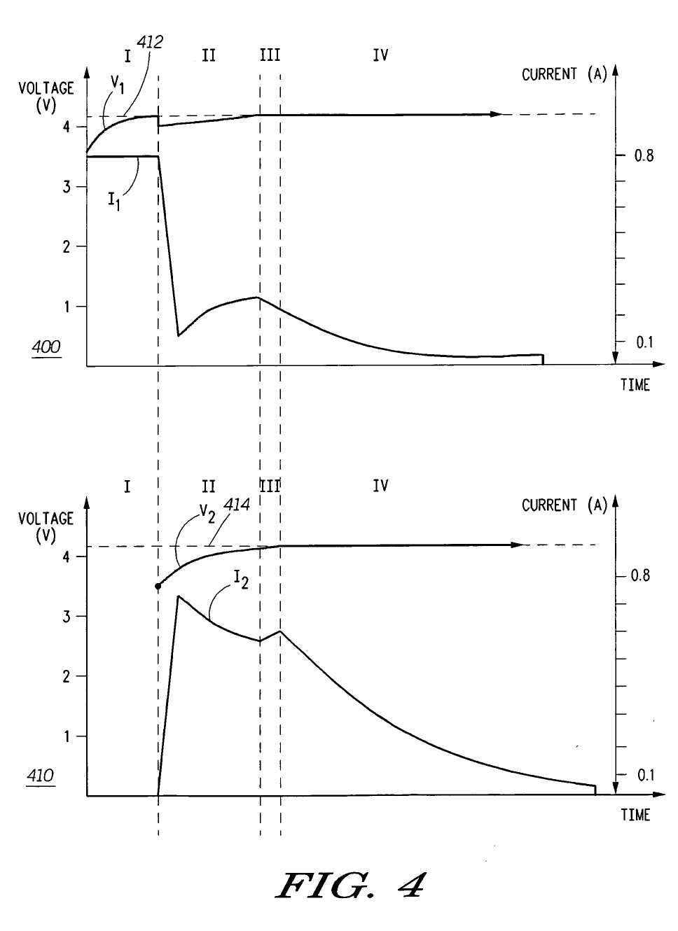

Referring to FIG. 4, two graphs are shown. A first graph 400 illustrates an example of voltage and current curves with respect to time for the first battery 116. A second graph 410 illustrates an example of voltage and current curves with respect to time for the second battery 118. Different stages of these graphs 400, 410 can be designated with Roman numerals I through IV.

For example, referring to FIGS. 2 and 4, in stage I, the processor 130 in the portable electronic device 112 can turn on or activate the first switch 134, and the second switch 122 can remain deactivated or off. Here, the processor 130 can cause the first switch 134 to be in a saturated state, and the power supply 138 can provide a current I₁ to the first battery 116. The processor 130 can monitor this current and the voltage at the power supply 138 through the current sensor 132. The processor 130 can also monitor the voltage of the first battery 116 (shown as V₁ in the graph 400) through the input 144. The processor 120 of the charger 110 can monitor the current I₁ and the voltage at the power supply 138 through the current sensor 128.

As noted earlier, the first switch 134 in stage I can be saturated. The term saturated can refer to a level of operation that can cause the power supply 138 to output a current that at least reaches the maximum rated current of the power supply 138. As those of skill in the art will appreciate, this process can cause the power supply 138 to be in a current-limited state. While in the current-limited state, those of skill in the art will also appreciate that the voltage at the power supply 138 may slump to a level, for example, that is slightly above the voltage of the first battery 116. As an example, the slumped voltage at the output of the power supply 138 may be approximately 0.3 volts above the voltage of the first battery 116. In this example, the rated maximum current of the power supply 138 may be 800 milli-amps (mA), and this is reflected in the current I₁ in stage 1.

Eventually, the voltage of the first battery 116 can reach a predetermined charging threshold 412. As an example, the predetermined charging threshold 412 can be the maximum charging voltage of the first battery 116. This point can mark the beginning of stage II for the graphs 400 and 410. The processor 130 of the portable electronic device 112 can detect that the voltage of the first battery 116 has reached the predetermined charging threshold 412 through the input 144. The processor 130 can access the maximum charge voltage of the first battery 116 though the EPROM connection. In one arrangement, the processor 130 can signal the processor 120 of the charger 110 through the data line 133 of this occurrence.

There are several other ways the processor 120 can determine that the first battery 116 has reached the predetermined charging threshold 412. For example, the processor 120 can monitor the voltage of the power supply 138 through the current sensor 128. Because it may be in a current-limited state, the voltage of the power supply 138 may be about 0.3 volts above the voltage of the first battery 116. Thus, the processor 120 can monitor the voltage of the power supply 138 to determine when the voltage of the first battery 116 has reached the predetermined charging threshold 412 (the maximum charging voltage of the first battery 116 may be programmed into the processor 120 to facilitate this process).

In another arrangement, the processor 130, once the first battery 116 has reached the predetermined charging threshold 412, can cause the first switch 134 to temporarily enter a non-saturated state. As an example, a non-saturated state can be a linear state of transistor operation. This change may reduce the amount of current flowing through the current sensor 128, which the processor 120 can detect. In view of the different ways that permit the processor 120 to detect when the first battery 116 has reached the predetermined charging threshold 412, it may not be necessary to implement both the data line 133 and the current sensor 128 in the system 100.

Once it determines that the first battery 116 has reached the predetermined charging threshold 412, the processor 120 can cause the second switch 122 to turn on and enter a saturated state. As a result, as shown in stage II, the current I₁ for the first battery 116 may drop, and the current I₂ for the second battery 118 can correspondingly rise. The voltage V₁ of the first battery 116 may also drop, and the voltage V₂ of the second battery 118 can begin to increase. At this point, both the first switch 134 and the second switch 122 can be in a saturated state. In addition, the power supply 138 may also remain in its current-limited state during stage II.

After the initial drop, the current I₁ for the first battery 116 can begin to rise. Following its initial increase, the current I₂ for the second battery 118 can begin to decrease. These currents I₁ and I₂ can eventually reach an equilibrium. During stage II, the sum of the current I₁ and the current I₂ can equal the maximum rated current of the power supply 138, e.g., 800 mA, to help keep the power supply 138 in its current-limited state. As explained above, this process reduces the voltage at the output of the power supply 138, which can reduce the amount of power to be dissipated in the charging system 100. If the power supply 138 were not maintained in a current-limited state, such as when the first switch 134 and the second switch 122 are in a non-saturated state, the voltage of the power supply 138 may increase. This increase in voltage can cause excessive heat to be dissipated.

The voltage V₁ of the first battery 116 may reach the predetermined charging threshold 412 a second time, which can mark the beginning of stage III. Here, the processor 130 can detect that the first battery 116 has reached the predetermined charging threshold 412 once again and can cause the first switch 134 to enter a non-saturated state, such as a linear state. This step can cause a decrease in the current I₁ of the first battery 116. The processor 120 can maintain the second switch 122 in the saturated state, which can cause the current I₂ for the second battery 118 to increase. As a result, the power supply 138 can be maintained in its current-limited state, which can keep its voltage minimized.

The voltage V₂ of the second battery 118 may also eventually reach a second predetermined charging threshold 414, which can be the maximum charging voltage of the second battery 118. This point can mark the beginning of stage IV. Here, the processor 120 can determine the maximum charging voltage of the second battery 118 through the EPROM contact. The processor 120 can also monitor the voltage of the second battery 118 through the input 127. When the second battery 118 reaches the second predetermined charging threshold 414, the processor 120 can cause the second switch 122 to enter a non-saturated state, such as a linear state. The current I₂ can begin to decrease, too.

The current I₂ can continue to decrease until cutoff, as shown and as appreciated by those of skill in the art. The current I₁ can also continue to decrease in stage IV until it reaches a cutoff threshold. The power dissipation can also be minimized in stage IV because both the current I₁ and the current I₂ are decreasing here.

Referring back to the method 300 of FIG. 3, the second alternative will now be described. In particular, at step 324, once the first battery reaches the predetermined charging threshold a first time, the first switch can be maintained in a non-saturated state, and the second switch can be maintained in the saturated state, at least until the second battery reaches a second predetermined charging threshold. The method 300 can then end at step 326.

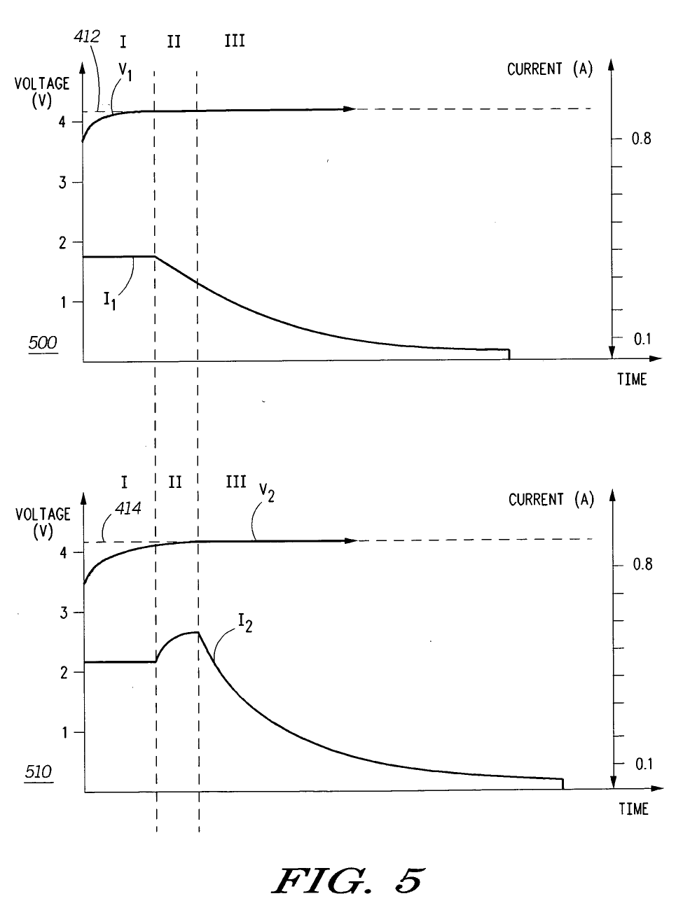

For example, referring once again to FIGS. 1 and 2, the portable electronic device 112 having the first battery 116 and the second battery 118 can be coupled to the charger 110, as previously described. Referring to FIG. 5, two more graphs are shown. In particular, a first graph 500 illustrates an example of voltage and current curves with respect to time for the first battery 116. A second graph 510 illustrates an example of voltage and current curves with respect to time for the second battery 118. Different stages of these graphs 500, 510 can be designated with Roman numerals I through III.

In this example, the existing charge on the first battery 116 may be higher than the existing charge on the second battery 118. This particular scenario is not meant to limit the invention in any way but is merely intended to help explain the inventive method. In stage I, the processor 130 of the portable electronic device 112 can cause the switch 134 to enter a saturation stage. Similarly, the processor 120 of the charger 110 can cause the second switch 122 to enter a saturated state. As a result, the first switch 134 and the second switch 122 can be simultaneously maintained in a saturated state during stage I. Similar to the description relating to FIG. 4, in stage I, the power supply 138 can be maintained in a current-limited state, which will reduce the power dissipation in the charger system 100.

Because it had a higher initial charge, the first battery 116 may reach the predetermined charging threshold 412 first. This point can represent the beginning of stage II. Here, the processor 130 can cause the first switch 134 to enter a non-saturated state, such as a linear state. As a result, the current I₁ can begin to decrease. Consequently, the current I₂ can begin to increase, as the second switch 122 can remain in the saturated state. As a result, the power supply 138 can remain in its current-limited state in stage II, which can maintain the process of reducing power dissipation in the charger system 100.

The voltage on the second battery 118 may eventually reach the second predetermined charging threshold 414, which can represent the beginning of stage III. The first switch 134 can remain in the non-saturated state. In addition, the processor 120 can cause the second switch 122 to enter a non-saturated state. As a result, the current I₂ can begin to decrease, and the current I₁ can continue to decrease, both to their cutoff thresholds. Again, because of the reductions in current, excessive power dissipation can be avoided during stage III.

In accordance with both examples, the first switch 134 and the second switch 122 can be simultaneously maintained in a saturated state for a certain amount of time to reduce power dissipation. Also, it should be noted that the overall amount of time to charge the first battery 116 and the second battery 118 can be reduced. This reduction in time is possible because the first battery 116 and the second battery 118 are simultaneously charged for at least a certain time period.

In another arrangement, the system 100 can be used to detect whether the power supply 138 is an authorized power supply. For example, if the first switch 134, the second switch 122 or both are in a saturated state, the power supply 138 should be in its current-limited state. If it is not, then the voltage at the output of the power supply 138 may not be minimized, as described earlier. This circumstance may indicate that the maximum rated current for the attached power supply is higher than what the charger 100 or the portable electronic device 112 are designed to receive. The processor 120 or the processor 130 can detect this lack of current-limiting state, and if necessary, can take certain safety steps. For example, the processor 120 and the processor 130 can respectively deactivate the second switch 122 and the first switch 134.

Although the above examples were described in terms of a first battery being in a portable electronic device coupled to a charger and the second battery being coupled to the charger, it is understood that the invention is not limited to this particular configuration. Those of skill in the art will appreciate that the above examples can be applied to more than just two batteries, as well. In fact, the method can be practiced using virtually any number of batteries and any suitable charging system.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for operating a multiple charger system, comprising:
in a multiple charger system having at least a first switch and a second switch for respectively controlling the flow of current to a first battery and a second battery, charging the first battery by maintaining the first switch in a saturated state; and
charging the second battery by maintaining the second switch in a saturated state, wherein the first switch and the second switch are simultaneously maintained in the saturated state at least until the first battery reaches a predetermined charging threshold.

2. The method according to claim 1, further comprising—while at least one of the first and second switches is in the saturated state—maintaining in a current limited state a power supply that provides the current to the first and second batteries.

3. The method according to claim 2, wherein maintaining the power supply in the current limited state reduces a voltage of the power supply in comparison to maintaining the power supply in a non-current limited state, which reduces a power dissipation in the multiple charger.

4. The method according to claim 1, further comprising maintaining the first switch in a saturated state and deactivating the second switch until the first battery reaches the predetermined charging threshold a first time.

5. The method according to claim 1, further comprising maintaining the first and second switches in the saturated state at least until the first battery reaches the predetermined charging threshold a second time.

6. The method according to claim 5, further comprising maintaining the second switch in the saturated state until the second battery reaches a second predetermined charging threshold.

7. The method according to claim 1, wherein once the first battery reaches the predetermined threshold a first time, the method further comprises maintaining the first switch in a non-saturated state and maintaining the second switch in the saturated state at least until the second battery reaches a second predetermined charging threshold.

8. The method according to claim 1, wherein at least one of the first battery and the second battery is used to power a mobile communications device.

9. A system for operating a multiple charger, comprising:
a first switch, wherein the first switch controls the flow of current to a first battery;
a second switch, wherein the second switch controls the flow of current to a second battery; and
a processing unit coupled to the first switch and the second switch, wherein the processing unit is programmed to:
charge the first battery by maintaining the first switch in a saturated state;
charge the second battery by maintaining the second switch in a saturated state; and
maintain the first switch and the second switch in the saturated state simultaneously at least until the processing unit detects that the first battery has reached a predetermined charging threshold.

10. The system according to claim 9, wherein the processing unit is further programmed to—while at least one of the first and second switches is in the saturated state—maintain in a current limited state a power supply that provides the current to the first and second batteries.

11. The system according to claim 10, wherein maintaining the power supply in the current limited state reduces a voltage of the power supply in comparison to maintaining the power supply in a non-current limited state, which reduces a power dissipation in the system.

12. The system according to claim 9, wherein the processing unit is further programmed to maintain the first switch in a saturated state and deactivate the second switch until the processing unit detects that the first battery has reached the predetermined charging threshold a first time.

13. The system according to claim 9, wherein the processing unit is further programmed to maintain the first and second switches in the saturated state at least until the processing unit detects that the first battery has reached the predetermined charging threshold a second time.

14. The system according to claim 13, wherein the processing unit is further programmed to maintain the second switch in the saturated state until the processing unit detects that the second battery has reached a second predetermined charging threshold.

15. The system according to claim 9, wherein once the processing unit detects that the first battery has reached the predetermined threshold a first time, the processing unit is further programmed to maintain the first switch in a non-saturated state and maintain the second switch in the saturated state at least until the processing unit detects that the second battery reaches a second predetermined charging threshold.

16. The system according to claim 9, wherein at least one of the first battery and the second battery is used to power a mobile communications device.

17. A charger for charging multiple batteries, comprising:
a first switch, wherein the first switch controls the flow of current from a power supply to a first battery; and
a processor coupled to the first switch, wherein the processor is programmed to:
charge the first battery by maintaining the first switch in a saturated state at the same time that a second switch is maintained in a saturated state to permit current to flow to a second battery, wherein the processor maintains the first switch in the saturated state while the second switch is in the saturated state at least until the processor detects that one of at least the first battery and the second battery has reached a predetermined charging threshold.

18. The charger according to claim 17, wherein the processor is further programmed to—while at least one of the first and second switches is in the saturated state—maintain in a current limited state a power supply that provides the current to the first and second batteries.

19. The charger according to claim 18, wherein maintaining the power supply in the current limited state reduces a voltage of the power supply in comparison to maintaining the power supply in a non-current limited state, which reduces a power dissipation in the charger.

20. The charger according to claim 17, wherein at least one of the first battery and the second battery is used to power a mobile communications device.
